(19) United States
(12) Patent Application Publication
(10) Pub. No.: US 2013/0147797 A1
(43) Pub. Date: Jun. 13, 2013

(54) THREE-DIMENSIONAL IMAGE GENERATING METHOD, THREE-DIMENSIONAL IMAGE GENERATING APPARATUS, AND DISPLAY APPARATUS PROVIDED WITH SAME

(71) Applicant: Yuhji Tanaka, Osaka-shi (JP)

(72) Inventor: Yuhji Tanaka, Osaka-shi (JP)

(73) Assignee: SHARP KABUSHIKI KAISHA, Osaka-shi, Osaka (JP)

(21) Appl. No.: 13/817,632

(22) PCT Filed: Jun. 1, 2011
(86) PCT No.: PCT/JP2011/062588

§ 371 Date: Feb. 19, 2013

(30) Foreign Application Priority Data
Aug. 30, 2010 (JP) 2010-192034

(51) Int. Cl. G06T 15/00

(52) U.S. Cl. CPC G06T 15/00
USPC 345/419

(57) ABSTRACT

In a three-dimensional image generating apparatus, a luminance gradient calculating portion calculates a luminance gradient, which indicates the amount of change in luminance between a pixel of interest and a pixel adjacent thereto, a right-eye image generating portion corrects a pixel luminance in a correction amount having the same sign as the luminance gradient, and a left-eye image generating portion corrects a pixel luminance in a correction amount having the opposite sign to the luminance gradient. As a result, there is a difference in luminance distribution between left-eye and right-eye images, so that stereoscopic viewing is made possible without calculating depth information, and there is no change in pixel positions, so that the images do not appear doubled or they are resistant to appearing doubled.

### TECHNICAL FIELD

The present invention relates to three-dimensional image generating methods, particularly to a method for generating a stereoscopically viewable, three-dimensional image from a planar (two-dimensional) image, and the invention also relates to an apparatus for generating such an image and a display apparatus including the same.

### BACKGROUND ART

Recently, there are sold a variety of display apparatuses that allow stereoscopic viewing, such as 3D television apparatuses. The 3D television apparatus provides stereoscopic display on the basis of a video source, such as a 3D movie, designed to be stereoscopically displayable.

However, two-dimensional images (planar images) provided by general television broadcasting are not designed to be stereoscopically displayable, and therefore, there is demand to generate stereoscopically displayable, three-dimensional images from such planar images.

There are various conventional techniques to convert planar images to three-dimensional images, and for example, Japanese Laid-Open Patent Publication No. 2002-245439 discloses a technique to obtain a three-dimensional shape of a subject at high speed from a grayscale image acquired by a monocular camera. Moreover, Japanese Laid-Open Patent Publication No. 2010-92283 discloses a technique to generate a stereoscopically viewable, stereo image from an image acquired by an endoscope.

### CITATION LIST

### Patent Documents

Patent Document 1: Japanese Laid-Open Patent Publication No. 2002-245439
Patent Document 2: Japanese Laid-Open Patent Publication No. 2010-92283

### SUMMARY OF THE INVENTION

### Problems to be Solved by the Invention

However, the technique disclosed in Japanese Laid-Open Patent Publication No. 2002-245439 requires in advance information such as the direction of illumination light and the reflectivity of the subject, and takes time in processing due to a large amount of computation required for calculating depth information.

In this regard, the technique disclosed in Japanese Laid-Open Patent Publication No. 2010-92283 does not require in advance information such as the direction of illumination light and the reflectivity of the subject, but takes time in processing as well due to a large amount of computation required for calculating depth information on the basis of luminances in an image.

Furthermore, in conventional techniques, including the above techniques, it is common to cause parallax by moving to the right or left the positions of a subject in left-eye and right-eye images, thereby allowing stereoscopic viewing. Accordingly, in the case of a display apparatus, e.g., a 3D television apparatus, in which left-eye and right-eye images are alternatingly displayed, and an active shutter for obstructing the vision of one eye in a viewer who is the user presents the images to the corresponding eyes, the left-eye and right-eye images are switched therebetween at high speed for alternating display, and therefore can appear doubled (displaced) in the eye of a viewer who is not using the active shutter (hence not the user). Note that this is approximately true for any technique (e.g., cross-eyed view method) that achieves stereoscopic viewing by simultaneously displaying left-eye and right-eye images.

Furthermore, in the case of such a conventional technique, the viewer who is using the active shutter often sees double (displacement) as well. So long as ideal conversion from planar images to a three-dimensional image is performed, the image should not appear doubled, but it is almost impossible to complement the three-dimensional image such that portions not shown in the planar images can be seen, and in fact, it is often the case that images with right-left displacement cannot be stereoscopically viewed and simply appear doubled.

Therefore, an objective of the present invention is to provide a method for generating a three-dimensional image that does not appear doubled or that is resistant to appearing doubled even when left-eye and right-eye images are displayed, without requiring computation for calculating depth information, and also to provide an apparatus for generating such a three-dimensional image and a display apparatus including the apparatus.

### Solution to the Problems

A first aspect of the present invention is directed to a three-dimensional image generating method for generating a stereoscopically viewable image on the basis of one or more input images, the method comprising:

a luminance gradient calculation step of calculating a luminance gradient from a pixel at a starting point to a pixel of interest at an ending point in the input image, the starting point and the ending point defining a luminance gradient calculation direction which corresponds to a direction from a first eye to a second eye of a user for stereoscopic viewing, the pixel at the starting point being adjacent to or neighboring the pixel of interest; and

a luminance-corrected image generation step of generating one or two luminance-corrected images from the input image by performing at least one of two corrections, one being a first correction to add a correction amount having the same positive or negative sign as the luminance gradient to a luminance of the pixel of interest, and the other being a second correction to add a correction amount having the opposite sign to the luminance gradient to the luminance of the pixel of interest, wherein,

in the luminance-corrected image generation step, either the luminance-corrected image obtained by the first correction or, when that image is not generated, the input image is outputted as an image to be presented to the second eye of the user, and either the luminance-corrected image obtained by the second correction or, when that image is not generated, the input image is outputted as an image to be presented to the first eye of the user.

In a second aspect of the present invention, based on the first aspect of the invention, in the luminance-corrected image generation step, the correction amount is set such that an absolute value thereof increases as an absolute value of the luminance gradient increases.

In a third aspect of the present invention, based on the second aspect of the invention, in the luminance-corrected image generation step, when the absolute value of the luminance gradient is greater than or equal to a predetermined threshold, the correction amount is set to zero considering the pixel of interest to be included at an edge of the input image.

A fourth aspect of the present invention is directed to a three-dimensional image generating apparatus for generating a stereoscopically viewable image on the basis of one or more input images, the apparatus comprising:

a gradient calculating portion for calculating a luminance gradient from a pixel at a starting point to a pixel of interest at an ending point in the input image, the starting point and the ending point defining a luminance gradient calculation direction which corresponds to a direction from a first eye to a second eye of a user for stereoscopic viewing, the pixel at the starting point being adjacent to or neighboring the pixel of interest; and

a luminance-corrected image generating portion for generating one or two luminance-corrected images from the input image by performing at least one of two corrections, one being a first correction to add a correction amount having the same positive or negative sign as the luminance gradient to a luminance of the pixel of interest, and the other being a second correction to add a correction amount having the opposite sign to the luminance gradient to the luminance of the pixel of interest, wherein,

the luminance-corrected image generating portion outputs an image to be presented to the second eye of the user and an image to be presented to the first eye of the user, the image to be presented to the second eye being either the luminance-corrected image obtained by the first correction or, when that image is not generated, the input image, the image to be presented to the first eye being either the luminance-corrected image obtained by the second correction or, when that image is not generated, the input image.

In a fifth aspect of the present invention, based on the fourth aspect of the invention, the luminance-corrected image generating portion performs only one of the first and second corrections to generate a luminance-corrected image.

In a sixth aspect of the present invention, based on the fourth aspect of the invention, the input images are stereoscopically viewable images and include a first input image to be presented to the second eye of the user and a second input image to be presented to the first eye of the user, and to enhance a stereoscopic effect to be produced for stereoscopic viewing of the input images, the luminance-corrected image generating portion outputs either a luminance-corrected image obtained by performing the first correction on the first input image or, when that image is not generated, the first input image as an image to be presented to the second eye of the user, and also outputs either a luminance-corrected image obtained by performing the second correction on the second input image or, when that image is not generated, the second input image as an image to be presented to the first eye of the user.

In a seventh aspect of the present invention, based on the sixth aspect of the invention, to reduce the stereoscopic effect to be produced for stereoscopic viewing of the input images, the luminance-corrected image generating portion outputs either a luminance-corrected image obtained by performing the second correction on the first input image or, when that image is not generated, the first input image as an image to be presented to the second eye of the user, and also outputs either a luminance-corrected image obtained by performing the first correction on the second input image or, when that image is not generated, the second input image as an image to be presented to the first eye of the user.

In an eighth aspect of the present invention, based on the fourth aspect of the invention, the luminance gradient calculating portion calculates the luminance gradient on the basis of luminances of a pixel-of-interest group and a starting-point-pixel group, the pixel-of-interest group including the pixel of interest and a pixel that is adjacent to or neighbors the pixel of interest, the starting-point-pixel group being a group of pixels that include the pixel at the starting point and are to be referenced as starting points.

In a ninth aspect of the present invention, based on the eighth aspect of the invention, the luminance gradient calculating portion obtains a difference value between a first combined value and a second combined value as the luminance gradient, the first combined value being obtained by adding up luminances of a pixel-of-interest group consisting of the pixel of interest and a plurality of pixels that are adjacent to or neighbor the pixel of interest in a direction perpendicular to the luminance gradient calculation direction, the second combined value being obtained by adding up luminances of a starting-point-pixel group consisting of pixels that are adjacent to or neighbor the pixel at the starting point in the luminance gradient calculation direction and also are adjacent to or neighbor one another in the direction perpendicular thereto.

In a tenth aspect of the present invention, based on the fourth aspect of the invention, the luminance-corrected image generating portion sets the correction amount such that an absolute value thereof increases as an absolute value of the luminance gradient increases.

In an eleventh aspect of the present invention, based on the fourth aspect of the invention, the luminance-corrected image generating portion limits the absolute value of the correction amount to a predetermined value or less.

In a twelfth aspect of the present invention, based on the fourth aspect of the invention, the luminance-corrected image generating portion sets the correction amount to zero when the pixel of interest is included at an edge of the input image.

In a thirteenth aspect of the present invention, based on the twelfth aspect of the invention, when the absolute value of the luminance gradient is greater than or equal to a predetermined threshold, the luminance-corrected image generating portion sets the correction amount to zero considering the pixel of interest to be included at an edge of the input image.

In a fourteenth aspect of the present invention, based on the fourth aspect of the invention, the luminance gradient calculating portion determines the luminance gradient calculation direction on the basis of externally provided information on the direction from the first eye to the second eye of the user, and calculates the luminance gradient in the determined luminance gradient calculation direction.

A fifteenth aspect of the present invention is directed to a three-dimensional image display apparatus comprising:

a three-dimensional image generating apparatus of the fourth aspect of the invention;

a display portion for alternatingly displaying an image to be provided to the first eye of the user and an image to be provided to the second eye; and

a shutter portion for, when the image to be provided to the first eye is displayed on the display portion, blocking the image not to be viewable to the second eye of the user and, when the image to be provided to the second eye is displayed, blocking the image not to be viewable to the first eye of the user.

### Effect of the Invention

According to the first aspect, a three-dimensional image that produces a significant stereoscopic effect can be generated by simple computation to calculate luminance gradients between pixels of interest and starting-point pixels, without requiring complicated computation to calculate depth information. Moreover, luminance corrections are simply performed, so that pixel positions do not change, and therefore, output images (typically, left-eye and right-eye images) can be prevented from appearing doubled, or can be rendered resistant to appearing doubled, when the images are displayed (for example, in an alternating manner). In addition, as a result, any viewer without an active shutter (any viewer other than the user thereof) can readily recognize the content of an image on, for example, a 3D television apparatus or suchlike of a frame sequential type, and therefore would not have an unpleasant feeling.

According to the second aspect, the correction amount is set such that its absolute value increases as the absolute value of the luminance gradient increases, and therefore, the stereoscopic effect can be enhanced where the luminance changes sharply.

According to the third aspect, when the absolute value of the luminance gradient is greater than or equal to the predetermined threshold, the correction amount is set to zero considering the pixel of interest to be included at an edge, and therefore, it is possible to avoid luminance changes to an abnormally great extent near the edge, and also to inhibit or eliminate the difference (in luminance) between two output images (typically, right-eye and left-eye images) near the edge. As a result, it is possible to reliably prevent the user from seeing double while viewing a three-dimensional image. Moreover, the luminance gradient, which is calculated in advance in order to calculate the correction amount, can be used for edge detection, and therefore, the edge detection can be performed by accurate and simple computation.

According to the fourth aspect, an effect similar to that achieved in the first aspect of the invention can be achieved with a three-dimensional image generating apparatus.

According to the fifth aspect, only one of the first and second corrections is performed, and therefore, when compared to the case where both are performed, a three-dimensional image that produces a significant stereoscopic effect can be generated by more simplified computation, without requiring complicated computation to calculate depth information.

According to the sixth aspect, a three-dimensional image that produces a further enhanced stereoscopic effect can be generated from first and second input images (typically, right-eye and left-eye images) by simple computation, without requiring complicated computation to calculate depth information. Moreover, the stereoscopic effect can be strengthened by increasing the absolute value of the correction amount, and therefore, the degree of strengthening the stereoscopic effect can be arbitrarily set.

According to the seventh aspect, a three-dimensional image that produces a further enhanced stereoscopic effect, or inversely, a reduced stereoscopic effect, can be generated from first and second input images (typically, right-eye and left-eye images) by simple computation. Moreover, the stereoscopic effect can be strengthened by increasing the absolute value of the correction amount or can be weakened by reducing the absolute value of the correction amount, so that the degree of strengthening or weakening the stereoscopic effect can be arbitrarily set.

According to the eighth aspect, the luminance gradient is calculated on the basis of the luminances of the pixel-of-interest group and the starting-point-pixel group, and therefore, in the case where there is an abnormal pixel value, i.e., there is influence of noise, such influence can be reduced compared to the case where a single pixel of interest is referenced as an ending point, and a single starting-point pixel is referenced as a starting point.

According to the ninth aspect, the difference between the first combined value, which is obtained by adding up the luminances of the pixel-of-interest group, and the second combined value, which is obtained by adding up the luminances of the starting-point-pixel group, is calculated as the luminance gradient, so that the influence of noise can be averaged and therefore reduced, and the luminance gradient can be calculated by simple computation.

According to the tenth aspect, the correction amount is set such that its absolute value increases as the absolute value of the luminance gradient increases, and therefore, the stereoscopic effect can be enhanced where the luminance changes sharply, as can be realized by the effect of the second aspect.

According to the eleventh aspect, the absolute value of the correction amount is limited to the predetermined value or less, and therefore, the luminance correction can be appropriately performed by preventing an abnormality (in an output image) due to the absolute value of the correction amount becoming excessively high.

According to the twelfth aspect, in the case where the pixel of interest is included at an edge of the input image, the correction amount is set to zero, and therefore, it is possible to avoid luminance changes to an abnormally great extent near the edge, and also to inhibit or eliminate the difference (in luminance) between two output images (typically, right-eye and left-eye images) near the edge. As a result, it is possible to reliably prevent the user from seeing double while viewing a three-dimensional image.

According to the thirteenth aspect, when the absolute value of the luminance gradient is greater than or equal to the predetermined threshold, the correction amount is set to zero considering the pixel of interest to be included at an edge, and therefore, the luminance gradient, which is calculated in advance in order to calculate the correction amount, can be used for edge detection, and therefore, the edge detection can be performed by accurate and simple computation.

According to the fourteenth aspect, the luminance gradient calculation direction is determined on the basis of the externally provided information on the direction from the first eye to the second eye of the user, and therefore, it is possible to generate a three-dimensional image (that produces a stereoscopic effect) so as to accord with the actual direction of parallax in accordance with, typically, the slope of the user's face.

According to the fifteenth aspect, an effect similar to that achieved in the fourth aspect of the invention can be achieved with a three-dimensional image display apparatus.

### BRIEF DESCRIPTION OF THE DRAWINGS

FIG. 1 is a block diagram illustrating the configuration of a three-dimensional image generating apparatus according to a first embodiment of the present invention.

FIG. 2 is a graph showing the relationship between the position and the luminance for some of the pixels included in an externally obtained planar image that are adjacent at the right and the left in the embodiment.

FIG. 3 is a graph showing the relationship between the position and the luminance gradient for the pixels shown in FIG. 2.

FIG. 4 is a graph showing the relationship between the position and the luminance for a corresponding pixel group in a right-eye image obtained by correcting the luminances of the pixel series of interest shown in FIG. 2.

FIG. 5 is a graph showing the relationship between the position and the luminance for a corresponding pixel group in a left-eye image obtained by correcting the luminances of the pixel series of interest shown in FIG. 2.

FIG. 6 is a block diagram illustrating the configuration of a three-dimensional image generating apparatus according to a second embodiment of the present invention.

FIG. 7 is a block diagram illustrating the configuration of a three-dimensional image generating apparatus according to a third embodiment of the present invention.

FIG. 8 is a table showing the correspondence between pixels around a pixel of interest and pixel data included in a video signal in a fourth embodiment of the present invention.

FIG. 9 is a graph showing the relationship between the position and the luminance for a corresponding pixel group in a right-eye image obtained by correcting the luminances of the pixel-of-interest group shown in FIG. 2, in a sixth embodiment of the present invention.

FIG. 10 is a graph showing the relationship between the position and the luminance for a corresponding pixel group in a left-eye image obtained in the embodiment.

FIG. 11 is a block diagram illustrating the configuration of a three-dimensional image generating apparatus according to a seventh embodiment of the present invention.

FIG. 12 is a block diagram illustrating in detail the configuration of a luminance gradient calculating portion in the embodiment.

### MODES FOR CARRYING OUT THE INVENTION

Hereinafter, embodiments of the present invention will be described with reference to the accompanying drawings.

### 1. First Embodiment

<1.1 Overall Configuration and Operation>

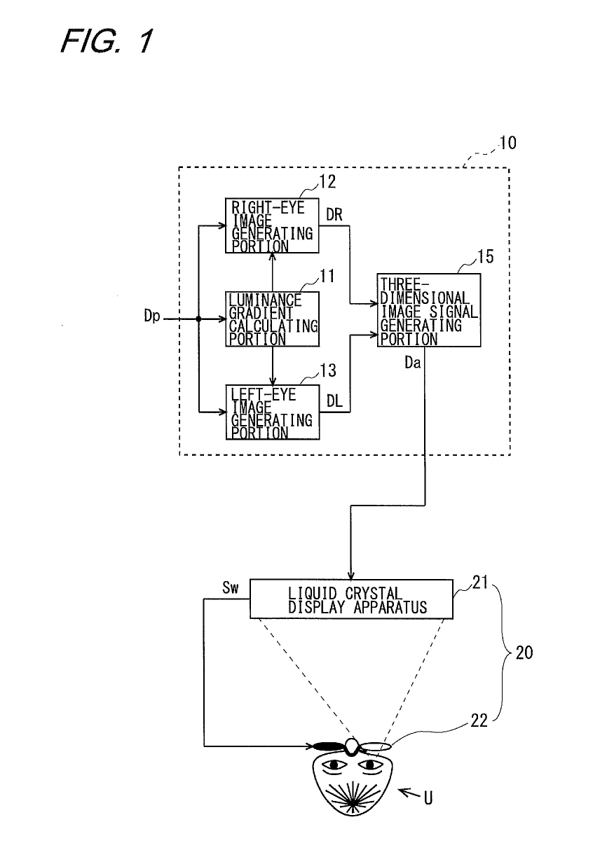

FIG. 1 is a block diagram illustrating the configuration of a three-dimensional image generating apparatus according to a first embodiment of the present invention. As shown in FIG. 1, the three-dimensional image generating apparatus 10 includes a luminance gradient calculating portion 11 for externally receiving a video signal Dp, which includes a planar image (two-dimensional image), and calculating luminance gradients between adjacent pixels in the planar image, a right-eye image generating portion 12 for generating a right-eye image DR on the basis of the planar image and the luminance gradients, a left-eye image generating portion 13 for generating a left-eye image DL on the basis of the planar image and the luminance gradients, and a three-dimensional image signal generating portion 15 for generating a three-dimensional image signal Da from the right-eye image DR and the left-eye image DL. Note that as will be described below, in the present invention, a temporal image change is irrelevant to three-dimensional image generation, and therefore, the video signal Dp, which herein is a dynamic image that changes every frame period, may be a still image. The three-dimensional image signal Da generated by the three-dimensional image signal generating portion 15 is provided to a 3D television apparatus 20. Note that the three-dimensional image generating apparatus 10 will be described as being independent of the 3D television apparatus 20, but it may be included in the 3D television apparatus 20.

The 3D television apparatus 20 includes a liquid crystal display apparatus 21 for alternatingly displaying the right-eye image DR and the left-eye image DL for a predetermined period of time (typically, a ½ frame period each) in accordance with the three-dimensional image signal Da, and an eyewear-like active shutter 22 for blocking the vision of the right or left eye in a user (viewer) U such that the right-eye image DR and the left-eye image DL are alternatingly provided to their corresponding eyes. In the example shown in FIG. 1, the liquid crystal display apparatus 21 displays the right-eye image DR, and the active shutter 22 blocks the vision of the left eye in the user U, thereby presenting the right-eye image DR to the right eye of the user. Note that the configuration of such a 3D television apparatus using an active shutter is well known, and therefore any detailed description thereof will be omitted.

Furthermore, besides the above method using the active shutter (also called a frame sequential method), display apparatuses which can provide stereoscopic display can employ well-known stereoscopic display methods, such as a lenticular lens method or a parallax barrier method. When any of such methods is employed, the right-eye image DR and the left-eye image DL are displayed simultaneously. Next, the configuration and the operation of the three-dimensional image signal generating portion 15 will be described in detail.

The luminance gradient calculating portion 11 shown in FIG. 1 calculates a luminance gradient between adjacent or neighboring pixels in a planar image or two-dimensional image (for one frame) included in an externally received video signal Dp, i.e., the degree of a change in luminance of a pixel (referred to below as a “pixel of interest”) over a pixel adjacent thereto, which, in this example, is positioned on the left, (referred to below as a “left pixel”). Note that, strictly, the luminance gradient is a derivative value of a so-called luminance function which represents the amount of change in luminance between pixels over distance, but the luminance gradient herein is intended to mean a value that indicates the rate of change in luminance between two horizontally adjacent pixels where the distance therebetween is taken as 1. Moreover, here, the direction from left to right will be referred to as a luminance gradient calculation direction.

Specifically, the luminance gradient calculating portion 11 includes a left-pixel luminance storage portion for storing (a luminance value of) an externally received video signal Dp for one pixel, and subtracts the luminance value stored in the left-pixel luminance storage portion from a received luminance value of a pixel of interest, thereby calculating a luminance gradient. Note that, strictly, the calculated value is a proportional value to the luminance gradient, which is a derivative value of a luminance function, and therefore needs to be divided by the actual distance between the left pixel and the pixel of interest, but the following descriptions will be given considering the calculated value as the luminance gradient and taking the distance between two adjacent pixels as 1, as described earlier. Note that in actual calculation, the distance between two pixels does not have to be taken as 1, as will be described later.

The right-eye image generating portion 12 outputs the luminance of the pixel of interest as a (pixel) value for the right-eye image DR after performing a luminance correction to increase the luminance when the luminance gradient received from the luminance gradient calculating portion 11 is positive, or after performing a luminance correction to decrease the luminance when the luminance gradient is negative. The amounts of increase and decrease in luminance may be constant. However, the amounts of increase and decrease in luminance preferably change in such a manner that they increase with the absolute value of the luminance gradient. By doing so, a natural stereoscopic effect can be produced, as will be described later. Accordingly, for example, the amounts of increase and decrease may be values each being obtained by multiplying the luminance gradient by a predetermined constant, or may be values obtained by predetermined formulae or values obtained on the basis of a table that defines the correspondence between values. The amounts of increase and decrease can be obtained as common correction amounts by multiplying the luminance gradient by constants, as will be described later. In such a configuration, the amount of increase corresponds to a correction amount where the luminance gradient is positive, and the amount of decrease corresponds to a correction amount where the luminance gradient is negative.

Furthermore, the left-eye image generating portion 13 outputs the luminance of the pixel of interest as a (pixel) value for the left-eye image DL after performing a luminance correction to decrease the luminance when the luminance gradient received from the luminance gradient calculating portion 11 is positive, or after performing a luminance correction to increase the luminance when the luminance gradient is negative. Here, for convenience of explanation, the absolute values of the amounts of increase and decrease in luminance (the correction amounts) are assumed to be the same as the absolute values of the amounts of increase and decrease (the correction amounts) for the right-eye image generating portion 12.

Specifically, as described earlier, when the right-eye image generating portion 12 performs a correction to increase the luminance, the left-eye image generating portion 13 performs a correction to decrease the luminance, the absolute value of the amount of increase (the amount of correction by the right-eye image generating portion 12) and the absolute value of the amount of decrease (the amount of correction by the left-eye image generating portion 13) are not in unique relationships with the amount of parallax (the amount of displacement) in the right direction and the amount of parallax (the amount of displacement) in the left direction. Accordingly, to produce the best stereoscopic effect, it is preferable to obtain the correction amounts through predetermined calculation or empirical rules, but for convenience of explanation, they are assumed to be the same value. In this manner, the left-eye image generating portion 13 performs opposite luminance correction operations to the right-eye image generating portion 12 in terms of increase and decrease.

The three-dimensional image signal generating portion 15 generates a three-dimensional image signal Da, which is adapted to alternatingly include every predetermined period of time (typically, every ½ frame period) a right-eye image DR outputted by the right-eye image generating portion 12 and a left-eye image DL outputted by the left-eye image generating portion 13. The three-dimensional image signal Da is reproduced by the 3D television apparatus 20, as described earlier, and is perceived (stereoscopically viewed) by the user U as a three-dimensional image.

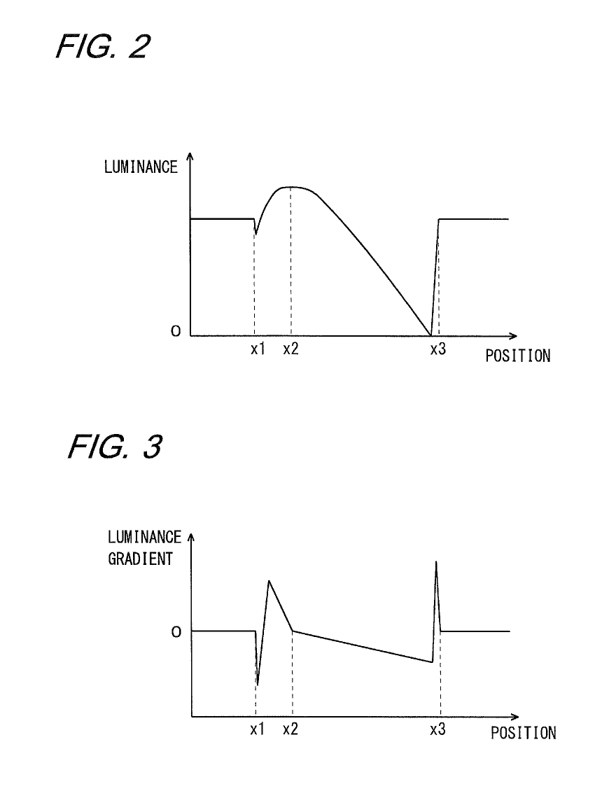

Note that the functions of the three-dimensional image generating apparatus 10 as above can be realized by hardware that includes predetermined logic circuits corresponding to the components described above, but they may be realized in a whole or in part by software. Specifically, by installing an operating system or predetermined application software into a general-purpose personal computer including a CPU (central processing unit), semiconductor memory, and a storage such as a hard disk, the functions corresponding to the above components may be realized by software. Next, the luminance correction operation of the three-dimensional image generating apparatus 10 will be specifically described with reference to FIGS. 2 to 5.

<1.2 Luminance Correction Operation by the Three-Dimensional Image Generating Apparatus>

FIG. 2 is a graph showing the relationship between the position and the luminance for some of the pixels included in an externally obtained planar image that are adjacent at the right and the left. FIG. 3 is a graph showing the relationship between the position and the luminance gradient for the pixels shown in FIG. 2. Note that the pixels shown in these figures will be referred to below as “a pixel series of interest”, the pixels included in the pixel series of interest are adjacent to one another at the right and the left and therefore have the same y-coordinate, and their x-coordinates correspond to the pixel positions shown in the figures.

As shown in FIGS. 2 and 3, for the pixels up to position x1 in the pixel series of interest, the luminance is constant (hence, the luminance gradient is 0). Then, the pixel luminance sharply drops from position x1 and rises shortly thereafter. At position x2, the tendency of the pixel luminance changes from rise to fall (after it is kept constant), i.e., the luminance gradient changes from the positive side through 0 to the negative side. Thereafter, the pixel luminance keeps falling, and sharply rises until it becomes constant at position x3 (where the luminance gradient becomes 0).

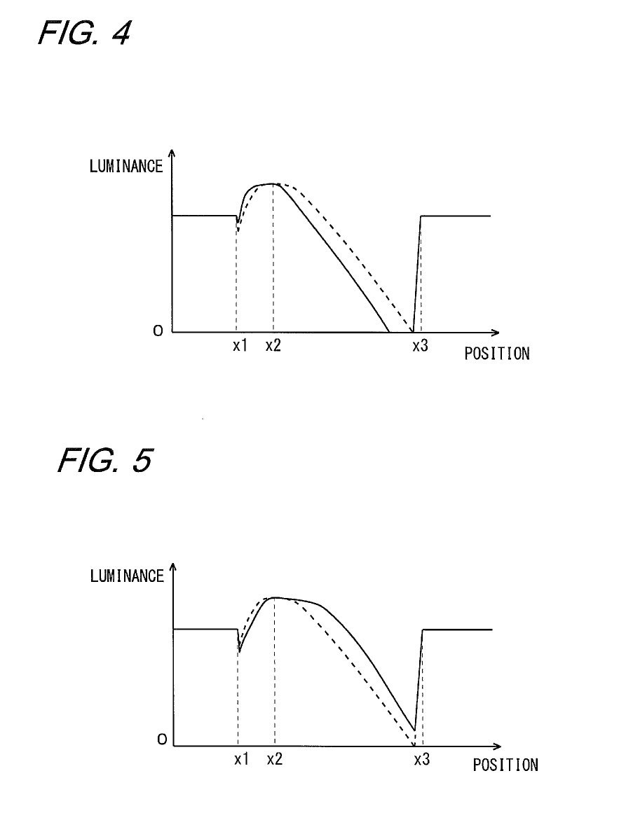

In this manner, the luminance gradient calculating portion 11 selects pixels of interest in the pixel series of interest one after another by shifting through the x-coordinates one by one from left to right, and calculates the luminance gradient of the selected pixel of interest. The calculated luminance gradient is provided to the right-eye image generating portion 12 and the left-eye image generating portion 13, as described earlier, thereby correcting the luminance of the pixel of interest. Specifically, the luminances of the pixel series of interest shown in FIGS. 2 and 3 are corrected as shown in FIG. 4 or 5.

FIG. 4 is a graph showing the relationship between the position and the luminance for a corresponding pixel group in a right-eye image obtained by correcting the luminances of the pixel series of interest shown in FIG. 2. Note that the dotted line in the figure represents the pixel series of interest shown in FIG. 2. As can be appreciated by comparing FIG. 4 with FIG. 2, for the pixels of interest up to position x1 whose corresponding pixels have their luminances kept invariable (and therefore have their luminance gradients at 0), their luminances are not corrected and therefore are left unchanged. For the subsequent pixels of interest up to position x2 whose corresponding pixels rise in luminance, their luminances are corrected to be higher, and for the pixels of interest beyond position x2 whose corresponding pixels fall in luminance, their luminances are corrected to be lower. Moreover, for the pixels of interest at and beyond position x3 whose corresponding pixels have their luminances kept invariable (and therefore have their luminance gradients at 0), their luminances are not corrected and therefore are left unchanged.

FIG. 5 is a graph showing the relationship between the position and the luminance for a corresponding pixel group in a left-eye image obtained by correcting the luminances of the pixel series of interest shown in FIG. 2. Note that the dotted line in the figure represents the pixel series of interest shown in FIG. 2. As can be appreciated by comparing FIG. 5 with FIG. 2, for the pixels of interest up to position x1 whose corresponding pixels have their luminances kept invariable (and therefore have their luminance gradients at 0), their luminances are not corrected and therefore are left unchanged. For the subsequent pixels of interest up to position x2 whose corresponding pixels rise in luminance, their luminances are corrected to be lower, and for the pixels of interest beyond position x2 whose corresponding pixels fall in luminance, their luminances are corrected to be higher. Moreover, for the pixels of interest at and beyond position x3 whose corresponding pixels have their luminances kept invariable (and therefore have their luminance gradients at 0), their luminances are not corrected and therefore are left unchanged.

Note that the post-correction luminance values of the pixels of interest shown in FIGS. 4 and 5 are values in fact subjected to so-called clipping correction so as not to exceed a predetermined maximum value or fall below a predetermined minimum value, but no correction is performed when the absolute value of the luminance gradient exceeds a predetermined edge detection threshold. Such a luminance correction operation will be described in detail later in conjunction with a sixth embodiment, and therefore any description thereof will be omitted here for convenience sake.

In this manner, the distribution of the post-correction luminances of the pixel series of interest shown in FIG. 4, which are included in the right-eye image DR, is shifted as a whole to the left when compared to the pre-correction luminances of the pixel series of interest shown in FIG. 2, and the distribution of the post-correction luminances of the pixel series of interest shown in FIG. 5, which are included in the left-eye image DL, is shifted as a whole to the right when compared to the pre-correction luminances of the pixel series of interest shown in FIG. 2. Accordingly, even when there is no change in position between corresponding pixels in the right-eye image DR and the left-eye image DL, the overall pixel luminance distribution changes, so that parallax of the eyes of the user U or a difference equivalent to parallax is caused, thereby allowing stereoscopic viewing. Moreover, when there is no change in position between corresponding pixels in the right-eye image DR and the left-eye image DL, the images are displayed on the liquid crystal display apparatus 21 while being switched therebetween (at short intervals), so that the images do not appear doubled to any viewer without the active shutter 22, or they are resistant to appearing doubled (even if there is a difference in luminance distribution between them).

Furthermore, in the configuration of the present embodiment, unlike in the conventional configuration, parallax is not caused by changing pixel positions between the left and right images, so that the images do not appear doubled even to the viewer with the active shutter 22, or they are resistant to appearing doubled (even if there is a difference in luminance distribution between them).

Here, when the right-eye image DR and the left-eye image DL are different in luminance distribution to such an extent as to cause parallax (or a difference equivalent to parallax), stereoscopic viewing is possible, but, for example, in the configuration where the right-eye image DR and the left-eye image DL are generated by moving the luminance distribution of a planar image a predetermined distance to the right and to the left, respectively, a significant stereoscopic effect is not necessarily produced. The reason for this configuration not producing a significant stereoscopic effect is related to the fact that the stereoscopic effect on an object that can be perceived owing to the difference in luminance distribution is high particularly when the object has a rounded convex surface such as a spherical surface. For example, in general, when a hemispherical convex surface is illuminated from (alight source at) the left, typically, the upper left, the surface highly reflects light at its upper left portion (specifically, via specular reflection and diffuse reflection), i.e., the surface has a high luminance portion. When the surface with such a high luminance portion is viewed from both the left eye and the right eye, the high luminance portion (luminance distribution) appears to be displaced in the left-right direction, and further, the high luminance portion appears wide to the left eye and narrow to the right eye. Through simple computation, the three-dimensional image generating apparatus 10 can (virtually) realize the state of luminance distribution where a curved surface is viewed from the left and the right eye in a (virtual) lighting environment as described above, and therefore can produce such a high stereoscopic effect that can be perceived from a rounded convex surface.

Furthermore, in the configuration of the present embodiment, an area of the high luminance portion that is near where the luminance peaks is an area where the sign of the luminance gradient changes from positive to negative, i.e., the luminance gradient is close to 0, and therefore no luminance correction is performed for this area, or the amount of luminance correction is extremely low. Accordingly, the peak luminance area is not shifted either to the left or to the right, and in this regard, the area is resistant to appearing doubled to the viewer with the active shutter 22.

<1.3 Effects of the First Embodiment>

As described above, the three-dimensional image generating apparatus 10 of the present embodiment can generate a three-dimensional image that produces a significant stereoscopic effect from a single planar image, by simple computation to calculate luminance gradients between adjacent pixels, without requiring complicated computation to calculate depth information. Moreover, since pixel positions do not change, the left-eye image and the right-eye image can be prevented from appearing doubled, or can be rendered resistant to appearing doubled, even when the images are displayed (typically, in an alternating manner). In addition, as a result, any viewer without the active shutter 22 (any viewer other than the user thereof) can readily recognize the content of an image on a 3D television apparatus or suchlike, typically, of a frame sequential type, and therefore would not have an unpleasant feeling.

<1.4 Variant of the First Embodiment>

The luminance gradient calculating portion 11 of the present embodiment calculates a luminance gradient that indicates the rate of change in luminance in the direction from a left pixel to a pixel of interest, i.e., in the luminance gradient calculation direction, but the direction from aright pixel to a pixel of interest may be set as the luminance gradient calculation direction to calculate a luminance gradient that indicates the rate of change in luminance in that direction. In such a configuration, the luminance gradient calculating portion 11 includes a right-pixel luminance storage portion for storing (a luminance value of) an externally received video signal Dp for one pixel.

Furthermore, in this configuration, the luminance gradient calculation direction is opposite to that in the first embodiment, and therefore, the right-eye image generating portion 12 and the left-eye image generating portion 13 are reversed in function. Specifically, the right-eye image generating portion 12 outputs the luminance of the pixel of interest as a (pixel) value for the right-eye image DR after performing a luminance correction to decrease the luminance when the luminance gradient is positive, or after performing a luminance correction to increase the luminance when the luminance gradient is negative. On the other hand, the left-eye image generating portion 13 outputs the luminance of the pixel of interest as a (pixel) value for the left-eye image DL after performing a luminance correction to increase the luminance when the luminance gradient is positive, or after performing a luminance correction to decrease the luminance when the luminance gradient is negative. As a result, when a curved surface as mentioned above is viewed, a high luminance portion appears narrow to the left eye and wide to the right eye, so that as opposed to the case of the first embodiment, a stereoscopic effect is produced as if the light source were actually positioned to the upper right.

Note that the stereoscopic effect produced by this variant is completely equal in degree to the stereoscopic effect produced by the configuration of the first embodiment. However, since in general it is often the case that an illumination source for imaging is disposed to the upper left, it is more possible that the configuration of the first embodiment is in better agreement with the position of an actual illumination source for an original planar image, and in this regard, it might be more suitable than the configuration of the variant. Moreover, the configuration of the first embodiment and the configuration of the variant are conceivably switched in accordance with the content of an image, a user operation input, etc., thereby switching the position of a (virtual) illumination source between upper left and upper right.

### 2. Second Embodiment

<2.1 Overall Configuration and Operation>

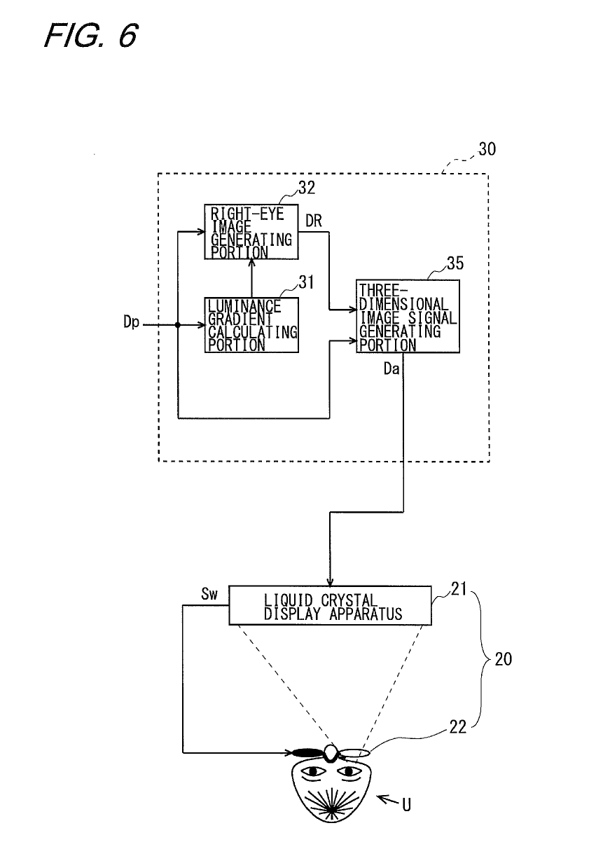

FIG. 6 is a block diagram illustrating the configuration of a three-dimensional image generating apparatus according to a second embodiment of the present invention. The three-dimensional image generating apparatus 30 shown in FIG. 6 includes a luminance gradient calculating portion 31 for externally receiving a planar image (two-dimensional image) Dp and calculating luminance gradients, in the same manner as in the luminance gradient calculating portion 11 of the first embodiment, a right-eye image generating portion 32 for generating a right-eye image DR on the basis of the planar image Dp and the luminance gradients, in the same manner as in the right-eye image generating portion 12 of the first embodiment, and a three-dimensional image signal generating portion 35 for generating a three-dimensional image signal Da on the basis of the right-eye image DR and the planar image, and the left-eye image generating portion 13 for generating the left-eye image DL in the first embodiment is omitted. Note that the 3D television apparatus 20 shown in FIG. 6 is the same as in the first embodiment shown in FIG. 1, and therefore any description thereof will be omitted.

<2.2 Luminance Correction Operation by the Three-Dimensional Image Generating Apparatus>

As described above, the left-eye image DL is not generated in the present embodiment, and instead, an original planar image is used. In such a configuration where the original planar image is presented to the left eye also, the right-eye image generating portion 32 performs a luminance correction such that the right-eye image DR presented to the right eye has luminance distribution in which a high luminance portion in the planar image is narrow and is positioned on the right side. Thus, a stereoscopic effect similar to that produced by the first embodiment can be achieved.

Here, in the first embodiment, the luminance correction is performed on the planar image equally in both the left and the right direction, and therefore, the amount of correction in the left and the right direction is higher than (typically, twice as high as) in the present embodiment. Accordingly, in the present embodiment, to perform a luminance correction to achieve the same sense of distance (amount of parallax) as in the first embodiment, the amount of correction by the right-eye image generating portion 32 needs to be increased (typically, doubled).

In this regard, as the absolute value of the amount of correction increases, the stereoscopic effect can be higher (i.e., the distance can be perceived to be closer), but the difference from the original planar image increases (i.e., the deviation in luminance distribution increases), resulting in a higher possibility of causing the viewer to perceive the image to be unnatural. In this regard, the configuration of the first embodiment can be said to be more preferable. However, the configuration of the second embodiment is simpler than the configuration of the first embodiment, and therefore is preferable in that device production cost can be cut down, and the amount of computation can be reduced.

Note that in the present embodiment, the left-eye image generating portion 13 is omitted, but a similar effect can be achieved even if the right-eye image generating portion 32 is omitted instead. Moreover, as in the variant of the first embodiment, the luminance gradient calculating portion 11 may calculate a luminance gradient that indicates the rate of change in luminance in the direction from a right pixel to a pixel of interest, which is set as the luminance gradient calculation direction, or the position of the (virtual) illumination source may be switched between upper left and upper right, as described earlier.

<2.3 Effects of the Second Embodiment>

As described above, the three-dimensional image generating apparatus 30 of the present embodiment can generate a three-dimensional image that can produce a significant stereoscopic effect, from a single planar image using more simplified computation than in the first embodiment, without requiring complicated computation for calculating depth information, and therefore even when the left-eye image and the right-eye image are displayed (typically, in an alternating manner), they do not appear doubled or they can be resistant to appearing doubled. Moreover, as a result, any viewer without the active shutter 22 can readily recognize the content of an image on a 3D television apparatus or suchlike, typically, of a frame sequential type, and therefore would not have an unpleasant feeling.

### 3. Third Embodiment

<3.1 Overall Configuration and Operation>

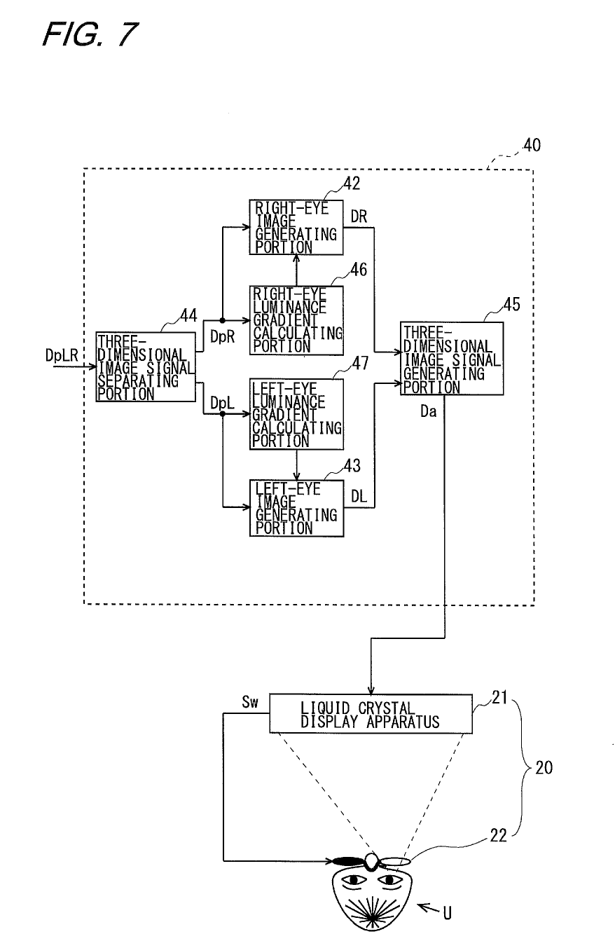

FIG. 7 is a block diagram illustrating the configuration of a three-dimensional image generating apparatus according to a third embodiment of the present invention. As shown in FIG. 7, the three-dimensional image generating apparatus 40 includes a three-dimensional image signal separating portion 44 for externally receiving a three-dimensional image signal DpLR, which includes a three-dimensional image, and outputting an external right-eye image DpR and an external left-eye image DpL after separating the images, a right-eye luminance gradient calculating portion 46 for receiving the external right-eye image DpR from the three-dimensional image signal separating portion 44 and calculating right-eye luminance gradients, a right-eye image generating portion 42 for generating a right-eye image DR on the basis of the external right-eye image DpR and the right-eye luminance gradients, a left-eye luminance gradient calculating portion 47 for receiving the external left-eye image DpL from the three-dimensional image signal separating portion 44 and calculating left-eye luminance gradients, a left-eye image generating portion 43 for generating a left-eye image DL on the basis of the external left-eye image DpL and the left-eye luminance gradients, and a three-dimensional image signal generating portion 45 for generating a three-dimensional image signal Da on the basis of the right-eye image DR and the left-eye image DL.

Note that the 3D television apparatus 20 shown in FIG. 7 has the same configuration as in the first embodiment shown in FIG. 1, and therefore any description thereof will be omitted. Moreover, the externally received three-dimensional image signal DpLR may be a signal conforming to the same frame sequential system as the three-dimensional image signal Da provided to the 3D television apparatus 20, or it may be a signal conforming to, for example, a so-called side-by-side system, in which an external right-eye image DpR is included in the right half of a (single) image provided per frame and an external left-eye image DpL is included in the left half, or a top-and-bottom system, in which the images are respectively included in the top and bottom halves.

In this manner, in the present embodiment, a three-dimensional image, rather than a planar image, is externally received, so that a three-dimensional image that can produce a significant stereoscopic effect can be generated even if no luminance correction is performed. However, an externally acquired three-dimensional image might produce an excessively high stereoscopic effect (i.e., distance can be perceived to be too close) or an excessively weak stereoscopic effect (i.e., distance can be perceived to be too far). For example, when a stereo camera or video device capable of acquiring a three-dimensional image is used to shoot an image of a person distanced relatively far from the device, the sense of distance (stereoscopic effect) can be correctly achieved such that the person is present in front of the background, but the stereoscopic effect to represent roundness of the person might not be achieved so that the person appears flat (e.g., as if the person were a figure painting on a board). In addition, in the case of the stereoscopic effect is excessively high, an issue such as eye fatigue might be caused. In such a case, the three-dimensional image generating apparatus 40 of the present embodiment can appropriately correct the stereoscopic effect (the sense of distance) in the externally acquired three-dimensional image. Hereinafter, such a luminance correction operation will be described.

<3.2 Luminance Correction Operation by the Three-Dimensional Image Generating Apparatus>

First, the right-eye luminance gradient calculating portion 46 includes a left-pixel luminance storage portion for storing a (luminance) value of an external right-eye image DpR for one pixel, as in the first embodiment, and calculates a right-eye luminance gradient by subtracting the luminance value stored in the left-pixel luminance storage portion from a received luminance value of a pixel of interest. Moreover, the left-eye luminance gradient calculating portion 47 calculates a left-eye luminance gradient in a similar manner.

Next, in the case where it is desirable to increase the stereoscopic effect for a reason as described earlier, e.g., the stereoscopic effect is not good enough to represent roundness of a far-distant person in an image, the right-eye image generating portion 42 outputs the luminance of a pixel of interest in the external right-eye image DpR as a (pixel) value of the right-eye image DR after performing a luminance correction to increase the luminance when the right-eye luminance gradient is positive, or after performing a luminance correction to decrease the luminance when the luminance gradient is negative. Moreover, the left-eye image generating portion 43 outputs the luminance of the pixel of interest in the external left-eye image DpL as a (pixel) value of the left-eye image DL after performing a luminance correction to decrease the luminance when the left-eye luminance gradient is positive, or after performing a luminance correction to increase the luminance when the luminance gradient is negative.

The result of the luminance corrections is such that the luminance distribution in the external right-eye image DpR shifts rightward, and the luminance distribution in the external left-eye image DpL shifts leftward, and therefore, the luminance distribution in the three-dimensional image results in a similar state to that achieved in the first embodiment. Thus, the stereoscopic effect (the sense of distance) can be further enhanced from the level of the stereoscopic effect to be realized by the externally acquired three-dimensional image signal DpLR, which includes a three-dimensional image. Note that the stereoscopic effect can be further enhanced by further increasing the absolute value of the amount of correction (the amount of increase or the amount of decrease), and therefore, the magnitude of the amount of correction may be determined in accordance with, for example, the type of an externally input image (the content of the three-dimensional image signal DpLR) or a user's selection operation.

Furthermore, inversely, when it is desirable to decrease (or cancel) the stereoscopic effect for such a reason as to prevent eye fatigue, the left-eye image generating portion 43 and the right-eye image generating portion 42 may be reversed in their luminance correction operations. The result of the luminance corrections is such that the luminance distribution in the external right-eye image DpR shifts to the left and the luminance distribution in the external left-eye image DpL shifts to the right, and therefore, the luminance distribution in the three-dimensional image results in a (directionally) opposite state to that achieved in the first embodiment. Thus, the stereoscopic effect (the sense of distance) can be reduced from the level of the stereoscopic effect to be realized by the externally acquired three-dimensional image signal DpLR, which includes a three-dimensional image. Note that in this case also, the magnitude of the amount of correction may be arbitrarily determined.

In this manner, the left-eye image generating portion 43 and the right-eye image generating portion 42 perform luminance correction operations differently from each other, either for increase or decrease, as in the first embodiment, but instead, as in the second embodiment, the right-eye luminance gradient calculating portion 46 and the right-eye image generating portion 42 may be omitted so that the luminance correction operation for the right-eye image is not performed, or the left-eye luminance gradient calculating portion 47 and the left-eye image generating portion 43 may be omitted so that the luminance correction operation for the left-eye image is not performed.

Furthermore, as in the variant of the first embodiment, the right-eye luminance gradient calculating portion 46 and the left-eye luminance gradient calculating portion 47 may calculate luminance gradients that indicate the rates of change in the direction from a right pixel to a pixel of interest, which is set as the luminance gradient calculation direction, or the position of the (virtual) illumination source may be switched between upper left and upper right, as described earlier.

<3.3 Effects of the Third Embodiment>

As described above, the three-dimensional image generating apparatus 40 of the present embodiment can generate a three-dimensional image that produces an enhanced stereoscopic effect, or inversely, a reduced stereoscopic effect, from (right-eye and left-eye images that realize) a three-dimensional image, by simple computation, without requiring complicated computation to calculate depth information. Moreover, the stereoscopic effect can be strengthened by increasing the absolute value of the amount of correction or can be weakened by reducing the absolute value of the amount of correction, so that the degree of strengthening or weakening the stereoscopic effect can be arbitrarily set. In addition, as in the first embodiment, since pixel positions do not change, the left-eye image and the right-eye image can be prevented from appearing doubled, or can be rendered resistant to appearing doubled, even when the images are displayed (typically, in an alternating manner).

### 4. Fourth Embodiment

<4.1 Overall Configuration and Operation>

The overall configuration and the operation of a three-dimensional image generating apparatus according to the present embodiment are the same as in the first embodiment shown in FIG. 1, except for the operation of the luminance gradient calculating portion 11, therefore, the same reference characters as in the first embodiment are assigned, and any descriptions of the components other than the luminance gradient calculating portion 11 will be omitted. Hereinafter, the luminance gradient calculation operation by the luminance gradient calculating portion 11 will be described.

<4.2 Luminance Gradient Calculation Operation by the Luminance Gradient Calculating Portion>

In the present embodiment, unlike in the first embodiment, the luminance gradient calculating portion 11 calculates a value corresponding to an average of three luminance gradients between three pixels, including pixels overlying and underlying a pixel of interest, (also referred to below as a “pixel-of-interest group”) and three pixels to the left of these three pixels, which are the starting points for calculating the luminance gradients, (also referred to below as a “starting-point-pixel group”).

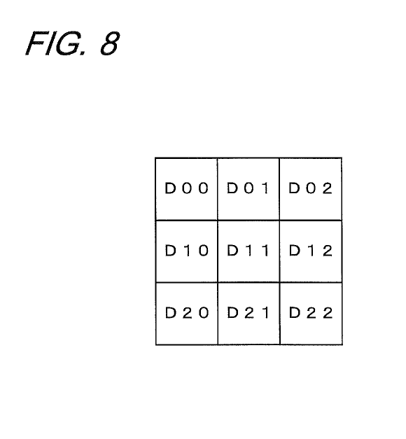

Note that the pixel-of-interest group may consist of two pixels including a pixel overlying or underlying the pixel of interest, or a plurality of pixels adjacent to or neighboring the pixel of interest (here, in the vertical direction). Similarly, the starting-point-pixel group may consist of a plurality of pixels adjacent to or neighboring one another (here, in the vertical direction). A specific description will be provided below with reference to FIG. 8.

FIG. 8 is a table showing the correspondence between pixels around the pixel of interest and pixel data included in a video signal. Pixel data D00 to D22 shown in FIG. 8 are arranged in a predetermined order at predetermined positions in the video signal Dp, and indicate luminance values (tone values) of corresponding pixels P(0,0) to P(2,2) on the display screen of the liquid crystal display apparatus 21.

Note that the actual video signal Dp includes luminance values for red (R), green (G), and blue (B), and the pixel P consists of three sub-pixels for displaying the colors R, G, and B, respectively, but these colors are not taken into account here for convenience of explanation, and the luminance values are assumed here to be averages of the three colors or luminance values for monochrome display. Note that an average of luminances among R, G, and B is equivalent to a brightness level, and therefore, the luminance value herein can be replaced with a brightness value of a color pixel consisting of three sub-pixels to produce a similar effect with a similar configuration. Therefore, instead of performing a luminance correction for each sub-pixel, a brightness correction maybe performed for each color pixel. For example, in a conceivable configuration, the luminances for R, G, and B are appropriately corrected in relation to one another, such that each of the colors approximates to white as the amount of brightness correction increases. Such a correction mode can be considered the same as the luminance correction for each color pixel.

Here, in the case where the pixel of interest is pixel P(1,1), a luminance gradient LG calculated by the luminance gradient calculating portion 11 has the relationship shown in equation (1) below with a luminance value indicated by corresponding pixel data D11 (the value will be represented below by D11, and other luminance values will also be represented in the same manner), luminance values D01 and D21 thereabove and therebelow, and pixel data D00, D10, and D20 corresponding to a starting-point-pixel group that is positioned to the left of the pixel-of-interest group.

LG=(D01+D11+D21)−(D00+D10+D20) (1)

The luminance gradient LG obtained in accordance with equation (1) is a value corresponding to an average of luminance gradients between the pixel-of-interest group and the starting-point-pixel group consisting of three pixels adjacent thereto at the left (the obtained value being three times higher than the average), and therefore is more resistant to noise (during transmission, computation, etc.) when compared to the configuration where the calculation is such that, for example, LG=D21−D20, as in the first embodiment. Specifically, in the case where the pixel of interest or the left adjacent pixel thereof is affected by noise and has an abnormal luminance value different from its original value, the luminance gradient therebetween also has an abnormal value, which is undesirably reflected in an image after luminance correction. However, there is only a small chance that both the underlying and overlying pixels and the left adjacent pixel are affected by noise, and therefore, the influence of noise can be reduced by obtaining the value corresponding to the average.

Furthermore, in the case where an abnormality occurs during image data transmission or during the abovementioned computation, the abnormality is often related to pixel data for one row or computation thereof, and therefore, by referencing data for different (overlaying and underlying) rows, i.e., by using the value corresponding to the average, the influence of noise can be reduced.

Note that the average of luminance gradients itself is ⅓ of the luminance gradient LG, but strictly, the luminance gradient herein is a proportional value for a luminance gradient, as described earlier, and the amounts of increase and decrease in luminance by luminance corrections are amounts uniquely corresponding to a luminance gradient, as described earlier, e.g., the values thereof are obtained by multiplying the luminance gradient by predetermined constants (unless the values are constant), therefore, the luminance gradient LG may be maintained as a value three times higher than the average. Moreover, as the pixel of interest, it is also possible to use, for example, a value obtained by well-known computation to reduce more or less the influence of noise, such as a value three times higher than a weighted average obtained by high weighting or a representative value.

Furthermore, as in the variant of the first embodiment, the luminance gradient calculation direction may be reversed. Specifically, the luminance gradient calculating portion 11 may calculate a luminance gradient that corresponds to an average of the rates of change in luminance between the right pixel and the pixel of interest and between the pixels overlying and underlying the right pixel and the pixels overlying and underlying the pixel of interest. Moreover, the position of the (virtual) illumination source may be switched between upper left and upper right, as described earlier.

<4.3 Effects of the Fourth Embodiment>

As described above, the three-dimensional image generating apparatus 10 of the present embodiment achieves a similar effect to that achieved in the first embodiment, and uses a value corresponding to an average of luminance gradients in the vertical direction to diminish the influence of noise (particularly, in the left-right direction), thereby reducing the abnormality in a three-dimensional image that is caused by an abnormal luminance correction operation.

Furthermore, the configuration of the present embodiment can be applied to the second or third embodiment (or a variant thereof). As a result, the effect specific to the second or third embodiment can be achieved in addition to the above effect.

### 5. Fifth Embodiment

<5.1 Overall Configuration and Operation>

The overall configuration and the operation of a three-dimensional image generating apparatus according to the present embodiment are the same as in the first embodiment shown in FIG. 1, except for the methods for calculating the amounts of increase and decrease for luminance corrections by the right-eye image generating portion 12 and the left-eye image generating portion 13, therefore, the same reference characters as in the first embodiment are assigned, and any descriptions of the same configuration and operation will be omitted. Hereinafter, the difference from the first embodiment, i.e., the methods for calculating the amounts of increase and decrease for luminance corrections by the right-eye image generating portion 12 and the left-eye image generating portion 13, will be described.

<5.2 Operation of Calculating the Amounts of Increase and Decrease for Luminance Corrections>

The right-eye image generating portion 12 and the left-eye image generating portion 13 in the present embodiment are characterized by performing luminance corrections based on the amounts of increase and decrease for luminance corrections according to the luminance gradient LG (referred to below as correction amounts) and also by performing clipping correction using predetermined maximum and minimum values Max and Min. Note that maximum value Max, which is positive, and minimum value Min, which is negative, are equal in absolute value here, and therefore, the clipping correction here means limiting the absolute value of a correction amount to a predetermined value or less.

First, in the case where luminance values of a pixel of interest before and after a luminance correction by the right-eye image generating portion 12 are DRp1 and DR1, respectively, and a constant is c (c>0), luminance value DR1 after the luminance correction according to the luminance gradient LG but before clipping correction is obtained by equation (2) below.

DR1=DRp1×(1+LG×c) (2)

In this manner, luminance value DR1 is obtained in accordance with the luminance gradient LG; here, the luminance gradient LG multiplied by constant c is added. The correction is performed such that the correction amount increases with the luminance gradient LG, as described above, thereby changing the luminance in a greater amount where the luminance changes sharply (e.g., near the border of the high luminance portion), so that the area of the high luminance portion becomes wider or narrower, resulting in a higher stereoscopic effect than the stereoscopic effect that is typically produced by a convex surface. Moreover, there is only low parallax (or a small difference corresponding to parallax) or no parallax created in a portion where a small or no luminance change occurs (e.g., a part of the high luminance portion near where the luminance peaks or an area where no stereoscopic effect is produced due to uniform luminance distribution), and therefore, the entire three-dimensional image is resistant to appearing doubled.

Next, luminance value DR1 as obtained above might be higher than a value allowable for display when its luminance gradient has the positive sign and an extremely high value, and even when the luminance value is not higher than the allowable value, the correction amount (the amount of increase) might be excessively high. On the other hand, the luminance value might be lower than the value allowable for display when the luminance gradient has the negative sign and an extremely low value (i.e., the absolute value of the luminance gradient is excessively high as mentioned earlier), and even when the luminance value is not lower than the allowable value, the absolute value of the correction amount (the amount of decrease) might be excessively high. Therefore, clipping correction using maximum value Max and minimum value Min is performed as in equations (3a) and (3b) below.

DR1=Min(DR1<Min) (3a)

DR1=Max(DR1>Max) (3b)

Note that in the case where Min≦DR1≦Max, luminance value DR1 does not change through clipping correction.

In this manner, in the case where luminance value DR1 is subjected to clipping correction, luminance value DR1 does not exceed maximum value Max or does not fall below minimum value Min, so that the luminance correction is appropriately completed.

Furthermore, when it is assumed here that luminance values of the pixel of interest before and after a luminance correction by the left-eye image generating portion 13 are DLp1 and DL1, respectively, and a constant is c, luminance value DL1 after the luminance correction but before clipping correction can be obtained as in equation (4) below.

DL1=DLp1×(1−LG×c) (4)

Thereafter, as in the case where equations (3a) and (3b) are used, clipping correction using maximum value Max and minimum value Min is performed as in equations (5a) and (5b) below.

DL1=Min(DL1<Min) (5a)

DL1=Max(DL1>Max) (5b)

Note that in the case where Min≦DL1≦Max, luminance value DL1 does not change.

Here, constant c may be a fixed value both in equations (2) and (4), but as in the third embodiment, constant c may be reduced for a higher stereoscopic effect and increased for a lower stereoscopic effect. For example, constant c may be determined in accordance with the type of an externally input image (the content of a video signal Dp), or a user's selection operation or suchlike.

Furthermore, as in the variant of the first embodiment, the luminance gradient calculating portion 11 may calculate a luminance gradient that indicates the rate of change in luminance in the direction from a right pixel to a pixel of interest, which is set as the luminance gradient calculation direction, or the position of the (virtual) illumination source may be switchable between upper left and upper right, as described earlier.

Note that the luminance gradient calculating portion 11 can omit either the determination of the amount of luminance correction according to the luminance gradient or the clipping correction. For example, even when the clipping correction is not performed, the stereoscopic effect can be enhanced where the luminance changes sharply, so long as the correction amount is set in accordance with the luminance gradient, specifically, such that the absolute value of the amount of luminance correction increases with the absolute value of the luminance gradient, and the overall stereoscopic effect can be achieved more satisfactorily when compared to the case where the amount of luminance correction is set regardless of the luminance gradient.

<5.3 Effects of the Fifth Embodiment>

As described above, the three-dimensional image generating apparatus 10 of the present embodiment achieves a similar effect to that achieved in the first embodiment; it is capable of increasing the stereoscopic effect where the luminance sharply increases by determining the amount of luminance correction such that the absolute value thereof increases with the absolute value of the luminance gradient, and it is also capable of appropriately performing a luminance correction by limiting the absolute value of the correction amount through clipping correction using maximum value Max and minimum value Min, such that the absolute value does not become excessively high.

Furthermore, the configuration of the present embodiment can be applied to any of the second through fourth embodiments (or variants thereof). As a result, in combination with the aforementioned effect, the effect specific to any one of the second through fourth embodiments can be further achieved.

### 6. Sixth Embodiment

<6.1 Overall Configuration and Operation>

The overall configuration and the operation of a three-dimensional image generating apparatus according to the present embodiment are the same as in the first embodiment shown in FIG. 1, except for the methods for calculating the amounts of increase and decrease for luminance corrections by the right-eye image generating portion 12 and the left-eye image generating portion 13, therefore, the same reference characters as in the first embodiment are assigned, and any descriptions of the components will be omitted except for the calculation methods. Moreover, in the present embodiment, the clipping correction of the fifth embodiment is performed in combination with deactivation of a luminance correction operation by means of an image edge detection (i.e., the operation of setting the correction amount to zero). Hereinafter, the luminance correction operations by the right-eye image generating portion 12 and the left-eye image generating portion 13 will be described.

<6.2 Operation for Calculating the Correction Amounts for Luminance Corrections>

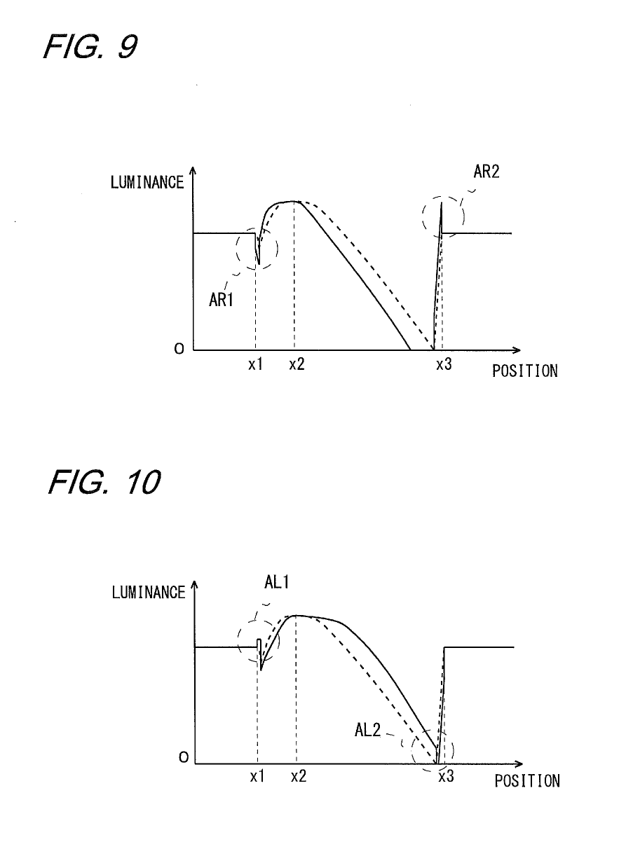

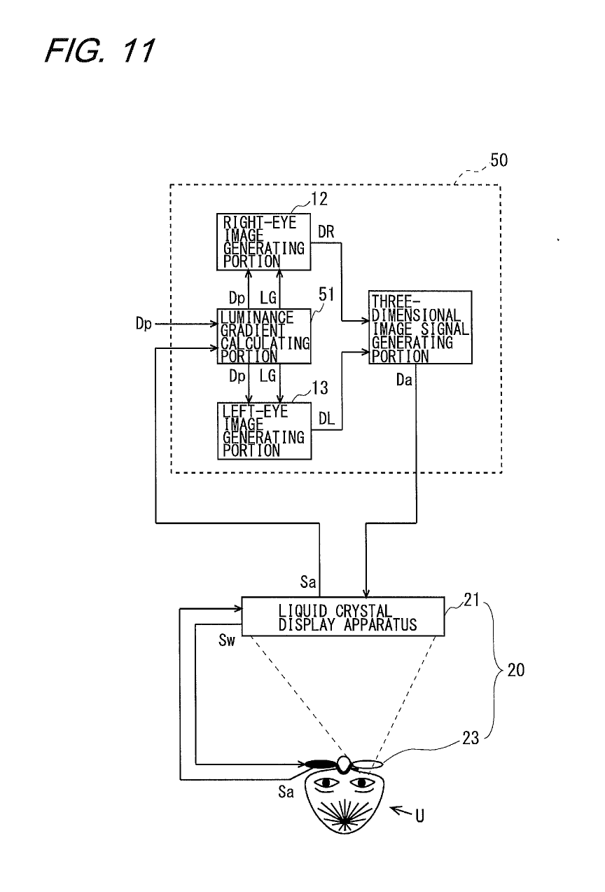

In addition to the luminance correction operation, which includes clipping correction, as in the fifth embodiment, the right-eye image generating portion 12 and the left-eye image generating portion 13 of the present embodiment further perform the operation of setting the correction amount to zero, thereby deactivating (omitting) luminance correction, when the absolute value |LG| of the luminance gradient LG is higher than edge detection threshold Eth. The reason for performing such an operation to deactivate luminance correction is to avoid a problem where, if the luminance correction operation continues to be performed, the luminance changes to an abnormally great extent near edges, causing an abnormality in a three-dimensional image to be generated. This problem will be described with reference to FIGS. 9 and 10.

FIG. 9 is a graph showing the relationship between the position and the luminance for a pixel group, which corresponds to the pixel series of interest shown in FIG. 2, in a right-eye image obtained by a luminance correction on that pixel series where the deactivation operation based on the edge detection is not performed. FIG. 10 is a graph showing the relationship between the position and the luminance for a corresponding pixel group in a left-eye image obtained by a similar luminance correction. Note that the dotted lines in the figures denote the pixel series of interest shown in FIG. 2. In areas AR1 and AR2 shown in FIG. 9, the deactivation operation is not performed, so that the luminance correction continues to be performed, resulting in luminance changes to an abnormally great extent. Such an abnormality occurs due to the following reasons. Specifically, the luminance gradient is known as being extremely high near edges of an image. As can be appreciated from equation (2), when the luminance gradient is significantly high, the correction amount is high, and therefore, the luminance value is corrected to change significantly (strictly, within the limits of neither exceeding the maximum value nor falling below the minimum value).

Furthermore, this abnormal luminance change occurs in the left-eye image as well, but in the opposite direction, as shown in FIG. 10. FIG. 10 shows the relationship between the position and the luminance for a pixel group, which corresponds to the pixel series of interest shown in FIG. 2, in a left-eye image obtained by a luminance correction on that pixel series where the deactivation operation based on the edge detection is not performed. In areas AL1 and AL2 shown in FIG. 10, the deactivation operation is not performed, so that the luminance correction continues to be performed, resulting in luminance changes to an abnormally great extent for the reasons mentioned above. Moreover, as can be appreciated by comparison between FIGS. 9 and 10, the direction in which the abnormal luminance change occurs is opposite between the left and the right such that the difference in luminance increases therebetween. As a result, when the user U views the two images as a three-dimensional image through the active shutter 22, the difference in luminance is significantly noticeable at portions of the image that correspond to the aforementioned areas, resulting in a more noticeable image abnormality.

Therefore, when the luminance changes to an abnormally great extent as described above, specifically, when the absolute value |LG| of the luminance gradient LG is higher than edge detection threshold Eth, the right-eye image generating portion 12 performs the operation of deactivating the luminance correction (by setting the correction amount to zero). Accordingly, regardless of the results of the luminance correction in accordance with equation (2) and the clipping correction in accordance with equation (4), where |LG|>Eth, DR1=DRp1. Moreover, in the left-eye image generating portion 13 also, where |LG|>Eth, DL1=DLp1. In this manner, by setting the correction amount to zero for edges, thereby deactivating the luminance correction, it is possible to prevent abnormal changes due to luminance correction as shown in FIGS. 4 and 5, so that occurrence of abnormality in images can be inhibited.

Note that for convenience sake, the above example has been described with reference to FIGS. 4 and 5 for the first embodiment, but in actuality, the clipping correction is performed along with the featured operation of the first embodiment, and no correction is performed when the absolute value of the luminance gradient is higher than a predetermined edge detection threshold, as described earlier.

Furthermore, the configuration of the present embodiment makes it possible to avoid luminance changes to an abnormally great extent near edges, and also to inhibit or eliminate the difference (in luminance) between the right-eye image and the left-eye image near edges. As a result, it is possible to reliably prevent the user from seeing double while viewing a three-dimensional image. Specifically, when an image appears doubled near edges, the entire image often appears doubled as well, but by inhibiting or eliminating the difference in luminance (between the left and right images) near edges, it is rendered possible to generate a three-dimensional image that is more resistant to appearing doubled or that does not appear doubled.

Furthermore, for this reason, in the present embodiment, so long as edges in an image are detected, edge detection may be performed, for example, on the basis of a well-known edge detection technique such as a technique using pattern recognition, rather than on the basis of the luminance gradient. However, the edge detection technique based on the luminance gradient is intended to be employed in well-known superior edge detection techniques such as Canny's method, and in the present embodiment, since the luminance gradient is required for calculating the correction amount, here, it is particularly appropriate to use the luminance gradient for the edge detection.

<6.3 Effects of the Sixth Embodiment>

As described above, the three-dimensional image generating apparatus 10 of the present embodiment achieves a similar effect to that achieved in the fifth embodiment, and is capable of not causing an abnormality in a three-dimensional image through deactivation of luminance correction by setting the correction amount to zero near edges when the luminance changes to an abnormally great extent near the edges.

Furthermore, the configuration of the present embodiment can be applied to any of the second through fourth embodiments (or variants thereof). As a result, in combination with the aforementioned effect, the effect specific to any one of the second through fourth embodiments can be further achieved.

### 7. Seventh Embodiment

<7.1 Overall Configuration and Operation>

FIG. 11 is a block diagram illustrating the configuration of a three-dimensional image generating apparatus according to a seventh embodiment of the present invention. As shown in FIG. 11, the three-dimensional image generating apparatus 50 includes a luminance gradient calculating portion 51 for externally receiving a planar image (two-dimensional image) and also receiving a slope Sa of an active shutter 23 from a 3D television apparatus 20 to calculate a luminance gradient in accordance with the slope Sa, and the three-dimensional image generating apparatus 50 also includes a right-eye image generating portion 12, a left-eye image generating portion 13, and a three-dimensional image signal generating portion 15, which operate in similar manners to those in the first embodiment. Note that there is a difference from the configuration of the first embodiment in that pixel data D11 obtained from the luminance gradient calculating portion 51 are provided to the right-eye image generating portion 12 and the left-eye image generating portion 13 as video signals Dp, as will be described later, since the video signals Dp to be provided to the right-eye image generating portion 12 and the left-eye image generating portion 13 are the pixel data D11 which specifically correspond to pixels of interest. Accordingly, this configuration can be applied to the first embodiment as well, details of which will be described later.

Furthermore, the 3D television apparatus 20 shown in FIG. 7 includes a liquid crystal display apparatus 21 similar to that in the first embodiment shown in FIG. 1, and the active shutter 23, which has the function of detecting the slope in addition to the same functions as in the first embodiment. The slope detecting function is realized by a well-known slope sensor, e.g., an acceleration sensor included in an (eyewear-like) frame which extends approximately in parallel with a line between the user's left and right eyes (the sensor being provided in parallel with that line).

For instance, in the case where the acceleration sensor detects a value equal to gravitational acceleration, the user's left and right eyes can be said to be parallel to the ground, such as when the user is sitting vertically to the ground (without leaning the body). In such a case, the active shutter 23 outputs slope Sa=0°.

Furthermore, in the case where the acceleration sensor detects a value equal to √2/2 of gravitational acceleration, for example, the user's left and right eyes can be said to lean 45° to the right or left relative to the ground. In such a case, the active shutter 23 outputs slope Sa=45° or Sa=−45°. Note that a determination as to which one of the values should be outputted is made based on the immediately preceding slope value, but another acceleration sensor may be provided in the vertical direction (or in the 45° direction), so that an output value thereof can be referenced as well.

Furthermore, in the case where the acceleration sensor does not detect gravitational acceleration, for example, the user's left and right eyes can be said to be perpendicular to the ground, such as when the user is lying sideways. In such a case, the active shutter 23 outputs slope Sa=90° or −90°. Note that one of these values that should be outputted is determined in the manner mentioned earlier.

<7.2 Luminance Gradient Calculation Operation by the Luminance Gradient Calculating Portion>

The luminance gradient calculating portion 51 receives a signal indicating the slope Sa (the signal will also be denoted by “Sa”), and calculates a luminance gradient corresponding to the slope. Specifically, where slope Sa=0, the luminance gradient calculating portion 51 calculates the luminance gradient in the direction from left to right of an image in accordance with, for example, equation (1), as in the fourth embodiment.

Furthermore, where slope Sa=90°, the luminance gradient calculating portion 51 calculates the luminance gradient in the direction from top to bottom, which is set as the luminance gradient calculation direction, in accordance with equation (6) below. Specifically, where the pixel of interest is pixel P(1, 1) in FIG. 8, as described earlier, the relationship among the following is given as in equation (6): pixel data D11 indicated by corresponding pixel data D11 and pixel data D10 and D12 (i.e., the pixel data correspond to a pixel-of-interest group) arranged to the left and the right in the direction perpendicular to the luminance gradient calculation direction (the direction from top to bottom); pixel data D00, D01, and D02 corresponding to pixels overlying and being adjacent to the pixel-of-interest group (i.e., the pixel data correspond to a starting-point-pixel group); and the luminance gradient LG calculated by the luminance gradient calculating portion 51.

LG=(D10+D11+D12)−(D00+D01+D02) (6)

Next, where slope Sa=45°, the luminance gradient calculating portion 51 calculates the luminance gradient in the direction from upper left to lower right, which is set as the luminance gradient calculation direction, in accordance with equation (7) below. Specifically, where the pixel of interest is pixel P(1,1), the relationship among the following is given as in equation (7): corresponding pixel data D11 and pixel data D02 and D20 respectively positioned to the upper right and the lower left; pixel data D00, D01, and D10 corresponding to a starting-point-pixel group approximately to the upper left of the pixel-of-interest group; and the luminance gradient LG calculated by the luminance gradient calculating portion 51.

LG=(D02+D11+D20)−(D00+D01+D10) (7)

Although the two pixels that correspond to pixel data D01 and D10 are positioned to the upper left of the pixel of interest and the pixels that correspond to pixel data D02 and D20, so as to neighbor but not to be adjacent to these pixels, the pixels neighboring to the upper left are taken into account in calculation for easy calculation.

Furthermore, where slope Sa=−45°, the luminance gradient calculating portion 51 calculates the luminance gradient in the direction from lower left to upper right, which is set as the luminance gradient calculation direction, in accordance with equation (8) below. Specifically, where the pixel of interest is pixel P(1,1), the relationship among the following is given as in equation (8): pixel value D11 and pixel values D00 and D22 respectively positioned to the upper left and the lower right; pixel data D20, D10, and D21 corresponding to a starting-point-pixel group neighboring to the lower left of the pixel-of-interest group; and the luminance gradient LG calculated by the luminance gradient calculating portion 51.

LG=(D00+D11+D22)−(D10+D20+D21) (8)

Note that where slope Sa=−90°, Sa=−135°, or Sa=−225°, the luminance gradient can be similarly detected through calculation based on corresponding pixel data, in accordance with any one from equations (6) to (8), with data for the right eye and data for the left eye being switched therebetween.

In this manner, by detecting the slope of the user's face (the slope of the line between the left and right eyes), thereby detecting the direction of parallax in a three-dimensional image, and calculating a luminance gradient in the luminance gradient calculation direction according to the direction of parallax, the amount of luminance correction can be set so as increase as the luminance gradient increases in the direction of parallax, resulting in a stereoscopic effect enhanced in the direction of parallax. Thus, the three-dimensional image can be generated so as to accord with the actual direction of parallax (the stereoscopic effect thereof accords with the actual direction of parallax).

Note that in already-created three-dimensional images, the direction of parallax is predetermined (as the left-right direction), and therefore, when the actual direction of parallax is shifted from the predetermined direction of parallax (the left-right direction), for example, by the user leaning the face, the stereoscopic effect is compromised (resulting in abnormal display). However, even in such a case, by using one of the three-dimensional images as a planar image, or by temporarily generating a planar image from the three-dimensional image and then subjecting the generated image to the featured operation of the present embodiment, thereby generating a three-dimensional image, normal image display can be achieved with a stereoscopic effect even if the direction of parallax is shifted by the user leaning the face.

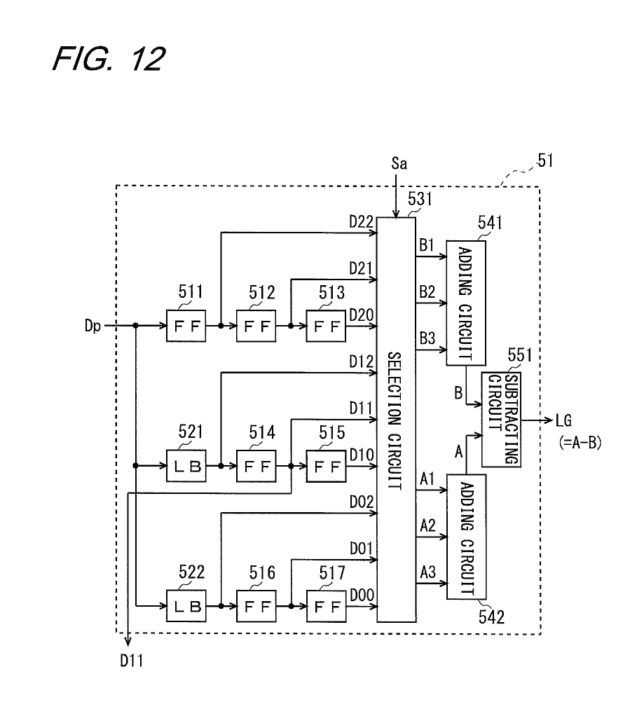

Here, to change the luminance gradient calculation method in accordance with the user leaning the face, as mentioned above, it is necessary to perform computation while sequentially extracting the nine pixel data D00 to D22 shown in FIG. 8 from the video signal Dp. This configuration will now be described in detail with reference to FIG. 12. Note that the video signal Dp is assumed to sequentially include the entire series of pixel data from top to bottom rows, with each row having pixel data arranged in a sequence from the left end to the right end. Moreover, the configuration to be described below includes the features of the first embodiment, as described earlier, and therefore can readily be applied to the first embodiment, and to other embodiments as well.

<7.3 Detailed Configuration and Operation of the Luminance Gradient Calculating Portion>

FIG. 12 is a block diagram illustrating in detail the configuration of the luminance gradient calculating portion 51. As shown in FIG. 12, the luminance gradient calculating portion 51 includes FFs (flip-flop circuits) 511 to 517, LBs (line buffer circuits) 521 and 522, a selection circuit 531, adding circuits 541 and 542, and a subtracting circuit 551.

The flip-flop circuits 511 to 517 store input pixel data for one pixel, and output the stored pixel data upon reception of the next input data. Note that the flip-flop circuits may be other well-known memory circuits such as latch circuits.

The line buffer circuits 521 and 522 store input pixel data for one row, and sequentially output the initially stored pixel data for one pixel at a time upon each reception of the next input data. Note that the line buffer circuits may be other well-known memory circuits.

Pixel data D00 to D22 included in the video signal Dp as shown in FIG. 8 are simultaneously provided to the selection circuit 531 by the flip-flop circuits 511 to 517 and the line buffer circuits 521 and 522. The aforementioned slope Sa is also provided to the selection circuit 531.

From among pixel data D00 to D22, the selection circuit 531 selects three pixel data that correspond to a pixel-of-interest group, in accordance with the slope Sa, as described earlier, and outputs the selected data to the adding circuit 541 as data B1 to B3, and the selection circuit 531 similarly selects three pixel data that correspond to a starting-point-pixel group, and outputs the selected data to the adding circuit 542 as data A1 to A3. For example, in the case where the active shutter 23 outputs slope Sa=90°, pixel data D10, D11, and D12 are selected and outputted as data A1 to A3, as shown in equation (6), and further, pixel data D00, D01, and D02 are selected and outputted as data B1 to B3.

The adding circuit 541 adds data B1 to B3, and outputs data B to the subtracting circuit 551, and the adding circuit 542 adds data A1 to A3, and outputs data A to the subtracting circuit 551. The subtracting circuit 551 subtracts data B from data A thus outputted, thereby calculating a luminance gradient LG. In this manner, calculation as in, for example, equations (6) to (8) is realized.

<7.4 Effects of the Seventh Embodiment>

As described above, the three-dimensional image generating apparatus 50 of the present embodiment achieves a similar effect to that achieved in the first embodiment, and is capable of detecting the slope of the user's face, thereby detecting the actual direction of parallax in a three-dimensional image, and therefore, by calculating a luminance gradient in the luminance gradient calculation direction in accordance with the direction of parallax, it is possible to generate the three-dimensional image so as to accord with the actual direction of parallax (and produce a stereoscopic effect).

Furthermore, the configuration of the present embodiment can be applied to any of the second through sixth embodiments (or variants thereof). As a result, in combination with the aforementioned effect, the effect specific to any one of the second through sixth embodiments can be further achieved.

### INDUSTRIAL APPLICABILITY

The present invention relates to a three-dimensional image generating method, a three-dimensional image generating apparatus, and a display apparatus including such an apparatus, and it is particularly suitable for display apparatuses, such as 3D televisions, which are provided with devices for generating stereoscopically viewable, three-dimensional images from planar (two-dimensional) images.

### DESCRIPTION OF THE REFERENCE CHARACTERS

10 three-dimensional image generating apparatus
11, 31, 51 luminance gradient calculating portion
12, 32, 42 right-eye image generating portion
13, 43 left-eye image generating portion
15,35,45 three-dimensional image signal generating portion
20 3D television apparatus
21 liquid crystal display apparatus
22, 23 active shutter
44 three-dimensional image signal separating portion
46 right-eye luminance gradient calculating portion
47 left-eye luminance gradient calculating portion
U user

1. A three-dimensional image generating method for generating a stereoscopically viewable image on the basis of one or more input images, the method comprising:
a luminance gradient calculation step of calculating a luminance gradient from a pixel at a starting point to a pixel of interest at an ending point in the input image, the starting point and the ending point defining a luminance gradient calculation direction which corresponds to a direction from a first eye to a second eye of a user for stereoscopic viewing, the pixel at the starting point being adjacent to or neighboring the pixel of interest; and
a luminance-corrected image generation step of generating one or two luminance-corrected images from the input image by performing at least one of two corrections, one being a first correction to add a correction amount having the same positive or negative sign as the luminance gradient to a luminance of the pixel of interest, and the other being a second correction to add a correction amount having the opposite sign to the luminance gradient to the luminance of the pixel of interest, wherein,
in the luminance-corrected image generation step, either the luminance-corrected image obtained by the first correction or, when that image is not generated, the input image is outputted as an image to be presented to the second eye of the user, and either the luminance-corrected image obtained by the second correction or, when that image is not generated, the input image is outputted as an image to be presented to the first eye of the user.

2. The three-dimensional image generating method according to claim 1, wherein in the luminance-corrected image generation step, the correction amount is set such that an absolute value thereof increases as an absolute value of the luminance gradient increases.

3. The three-dimensional image generating method according to claim 2, wherein in the luminance-corrected image generation step, when the absolute value of the luminance gradient is greater than or equal to a predetermined threshold, the correction amount is set to zero considering the pixel of interest to be included at an edge of the input image.

4. A three-dimensional image generating apparatus for generating a stereoscopically viewable image on the basis of one or more input images, the apparatus comprising:
a luminance gradient calculating portion for calculating a luminance gradient from a pixel at a starting point to a pixel of interest at an ending point in the input image, the starting point and the ending point defining a luminance gradient calculation direction which corresponds to a direction from a first eye to a second eye of a user for stereoscopic viewing, the pixel at the starting point being adjacent to or neighboring the pixel of interest; and
a luminance-corrected image generating portion for generating one or two luminance-corrected images from the input image by performing at least one of two corrections, one being a first correction to add a correction amount having the same positive or negative sign as the luminance gradient to a luminance of the pixel of interest, and the other being a second correction to add a correction amount having the opposite sign to the luminance gradient to the luminance of the pixel of interest, wherein,
the luminance-corrected image generating portion outputs an image to be presented to the second eye of the user and an image to be presented to the first eye of the user, the image to be presented to the second eye being either the luminance-corrected image obtained by the first correction or, when that image is not generated, the input image, the image to be presented to the first eye being either the luminance-corrected image obtained by the second correction or, when that image is not generated, the input image.

5. The three-dimensional image generating apparatus according to claim 4, wherein the luminance-corrected image generating portion performs only one of the first and second corrections to generate a luminance-corrected image.

6. The three-dimensional image generating apparatus according to claim 4, wherein,
the input images are stereoscopically viewable images and include a first input image to be presented to the second eye of the user and a second input image to be presented to the first eye of the user, and
to enhance a stereoscopic effect to be produced for stereoscopic viewing of the input images, the luminance-corrected image generating portion outputs either a luminance-corrected image obtained by performing the first correction on the first input image or, when that image is not generated, the first input image as an image to be presented to the second eye of the user, and also outputs either a luminance-corrected image obtained by performing the second correction on the second input image or, when that image is not generated, the second input image as an image to be presented to the first eye of the user.

7. The three-dimensional image generating apparatus according to claim 6, wherein to reduce the stereoscopic effect to be produced for stereoscopic viewing of the input images, the luminance-corrected image generating portion outputs either a luminance-corrected image obtained by performing the second correction on the first input image or, when that image is not generated, the first input image as an image to be presented to the second eye of the user, and also outputs either a luminance-corrected image obtained by performing the first correction on the second input image or, when that image is not generated, the second input image as an image to be presented to the first eye of the user.

8. The three-dimensional image generating apparatus according to claim 4, wherein the luminance gradient calculating portion calculates the luminance gradient on the basis of luminances of a pixel-of-interest group and a starting-point-pixel group, the pixel-of-interest group including the pixel of interest and a pixel that is adjacent to or neighbors the pixel of interest, the starting-point-pixel group being a group of pixels that include the pixel at the starting point and are to be referenced as starting points.

9. The three-dimensional image generating apparatus according to claim 8, wherein the luminance gradient calculating portion obtains a difference value between a first combined value and a second combined value as the luminance gradient, the first combined value being obtained by adding up luminances of a pixel-of-interest group consisting of the pixel of interest and a plurality of pixels that are adjacent to or neighbor the pixel of interest in a direction perpendicular to the luminance gradient calculation direction, the second combined value being obtained by adding up luminances of a starting-point-pixel group consisting of pixels that are adjacent to or neighbor the pixel at the starting point in the luminance gradient calculation direction and also are adjacent to or neighbor one another in the direction perpendicular thereto.

10. The three-dimensional image generating apparatus according to claim 4, wherein the luminance-corrected image generating portion sets the correction amount such that an absolute value thereof increases as an absolute value of the luminance gradient increases.

11. The three-dimensional image generating apparatus according to claim 4, wherein the luminance-corrected image generating portion limits the absolute value of the correction amount to a predetermined value or less.

12. The three-dimensional image generating apparatus according to claim 4, wherein the luminance-corrected image generating portion sets the correction amount to zero when the pixel of interest is included at an edge of the input image.

13. The three-dimensional image generating apparatus according to claim 12, wherein, when the absolute value of the luminance gradient is greater than or equal to a predetermined threshold, the luminance-corrected image generating portion sets the correction amount to zero considering the pixel of interest to be included at an edge of the input image.

14. The three-dimensional image generating apparatus according to claim 4, wherein the luminance gradient calculating portion determines the luminance gradient calculation direction on the basis of externally provided information on the direction from the first eye to the second eye of the user, and calculates the luminance gradient in the determined luminance gradient calculation direction.

15. A three-dimensional image display apparatus comprising:
a three-dimensional image generating apparatus of claim 4;
a display portion for alternatingly displaying an image to be provided to the first eye of the user and an image to be provided to the second eye; and
a shutter portion for, when the image to be provided to the first eye is displayed on the display portion, blocking the image not to be viewable to the second eye of the user and, when the image to be provided to the second eye is displayed, blocking the image not to be viewable to the first eye of the user.
